(19) United States
(12) Patent Application Publication
(10) Pub. No.: US 2014/0115447 A1
(43) Pub. Date: Apr. 24, 2014

(54) Centering Mathematical Objects in Documents

(71) Applicant: APPLE INC., Cupertino, CA (US)

(72) Inventors: Ian J. Elseth, Vancouver, WA (US); Christopher E. Rudolph, Vancouver, WA (US); Donald R. Beaver, Pittsburgh, PA (US); Allison M. Styer, San Francisco, CA (US); Martin J. Murrett, Portland, OR (US)

(73) Assignee: APPLE INC., Cupertino, CA (US)

(21) Appl. No.: 13/657,813

(22) Filed: Oct. 22, 2012

(51) Int. Cl. G06F 17/00

(52) U.S. Cl. 715/249

(57) ABSTRACT

A content presentations editing application for editing a structured electronic document that includes mathematical objects is provided. The content presentation editing application selects a portion of the document, the selected portion including at least one mathematical object. The content presentation editing application centers the selected portion of the document by identifying an alignment symbol in the mathematical object and aligning the mathematical object to a particular position in the document at the identified alignment symbol. To align the mathematical object, some embodiments move the mathematical object such that the alignment symbol is at the center of the page. For mathematical objects that are located within cells of a table, the center alignment operation moves each mathematical object in the table such that the identified alignment symbol aligns with the center of the table column that contains the mathematical object.

### BACKGROUND

In recent years, desktop publishing software has enabled users of inexpensive personal computers to create documents or printed materials using page layouts. When used skillfully, desktop publishing software can produce printed literature with attractive layouts and typographic quality comparable to traditional typography and printing. Word processing software has likewise evolved to include some capabilities previously available only with professional printing or desktop publishing. This technology allows individuals, businesses, and other organizations to self-publish a wide range of printed matter—from menus, books, magazines, newspapers to scholarly papers. In order to produce literatures or documents with professional looking mathematical or scientific equations, some desktop publishing or word processing software provides specialized tools such as Equation Editor® that allows the user to construct equations in a WYSIWYG environment.

For a document being authored by desktop publishing software to appear professional, the various content or objects in the pages of the document must be aligned properly. For most objects in a document such as text and images, alignment is a trivial operation based on the visual boundary of these objects. However, aligning a mathematical equation by its boundary rarely succeeds in producing visually satisfying result. This is particularly acute when aligning a group of mathematical equations to the center of the page. Though the boundaries of the equations are equally spaced from both margins of the page, the symbols within these equations such as relational operators will not line up in any meaningful way. To make the equations align properly, the user must manually move each equation or intervene in the alignment operation by defining an alignment point.

What is needed is a document authoring application that automatically performs center alignment of mathematical equations in a visually meaningful manner rather than simply relying on boundaries. Such alignment operation can produce equations in which the mathematical symbols lines up properly.

### BRIEF SUMMARY

Some embodiments of the invention provide a content presentation editing application for editing structured electronic documents that include mathematical objects. The content presentation editing application selects a portion of the document. The selected portion of the document includes at least one mathematical object. The content presentation editing application centers the selected portion of the document by identifying an alignment symbol in the mathematical object and aligning the mathematical object to a particular position in the document at the identified alignment symbol. To align the mathematical object, some embodiments move the mathematical object such that the alignment symbol is at the center of the page. For mathematical objects that are located within cells of a table, the center alignment operation moves each mathematical object in the table such that the identified alignment symbol aligns with the center of the table column that contains the mathematical object.

To identify the alignment symbol in an mathematical object, some embodiments construct a search tree by parsing the mathematical object. Each leaf node of the search tree corresponds to a character in the mathematical object. The content presentation editing application identifies the alignment symbol from the search tree by traversing the search tree in a depth first manner. In some embodiments, a relational operator that is encountered before any other relational operator during the traversal of the search tree is identified as the alignment symbol. In some embodiments, a relational operator that is visually nested within the mathematical object is excluded from being identified as the alignment symbol.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a center alignment operation involving the mathematical objects in a document.

FIG. 2 conceptually illustrates a process 200 that performs a center alignment operation for a selected portion of a document that includes a mathematical object.

FIG. 3 illustrates the center alignment operation for a portion of a document that includes a mathematical object that is embedded in a text object.

FIG. 4 illustrates a search tree for identifying a relational operator for alignment from a mathematical expression.

FIG. 5 conceptually illustrates a process for constructing a search tree by parsing a mathematical expression.

FIG. 6 illustrates the traversal of a search tree for identifying a relational operator as the alignment symbol.

FIG. 7 illustrates the identification of an alignment symbol in a mathematical object that includes deeply nested relational operators.

FIG. 8 illustrates the identification of a relational operator as an alignment symbol when the mathematical objects include nested expressions in superscript or subscripts.

FIG. 9 illustrates an example mathematical object in which all of the relational operators are visually nested.

FIG. 10 conceptually illustrates a process for identifying an alignment symbol from a search tree.

FIG. 11 conceptually illustrates a process that is used by some embodiments to select or identify an alignment symbol from a group of eligible relational operators.

FIG. 12 illustrates a center alignment operation for mathematical objects within a table.

FIG. 13 illustrates the exclusion of a relational operator from consideration as an alignment symbol for an equation within a table.

FIG. 14 illustrates a center-align operation for mathematical objects in multiple columns of a table.

FIG. 15 conceptually illustrates the software architecture of a document authoring application.

FIG. 16 illustrates a data structure of a content presentation or a structured electronic document that can be authored or edited by a document authoring application or content presentation editing application.

FIG. 17 conceptually illustrates an electronic system with which some embodiments of the invention are implemented.

### DETAILED DESCRIPTION

In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail.

Some embodiments of the invention provide a content presentation editing application for editing structured electronic documents that include mathematical objects. The content presentation editing application selects a portion of the document. The portion of the document includes at least one mathematical object. The content presentation editing application centers the selected portion of the document by identifying an alignment symbol in the mathematical object and aligning the mathematical object to a particular position in the document at the identified alignment symbol.

To identify the alignment symbol, some embodiments construct a search tree by parsing the mathematical object. Each leaf node of the search tree corresponds to a character in the mathematical object. The content presentation editing application identifies the alignment symbol from the search tree by traversing the search tree in a depth first manner. In some embodiments, a relational operator that is encountered before any other relational operator during the traversal of the search tree is identified as the alignment symbol.

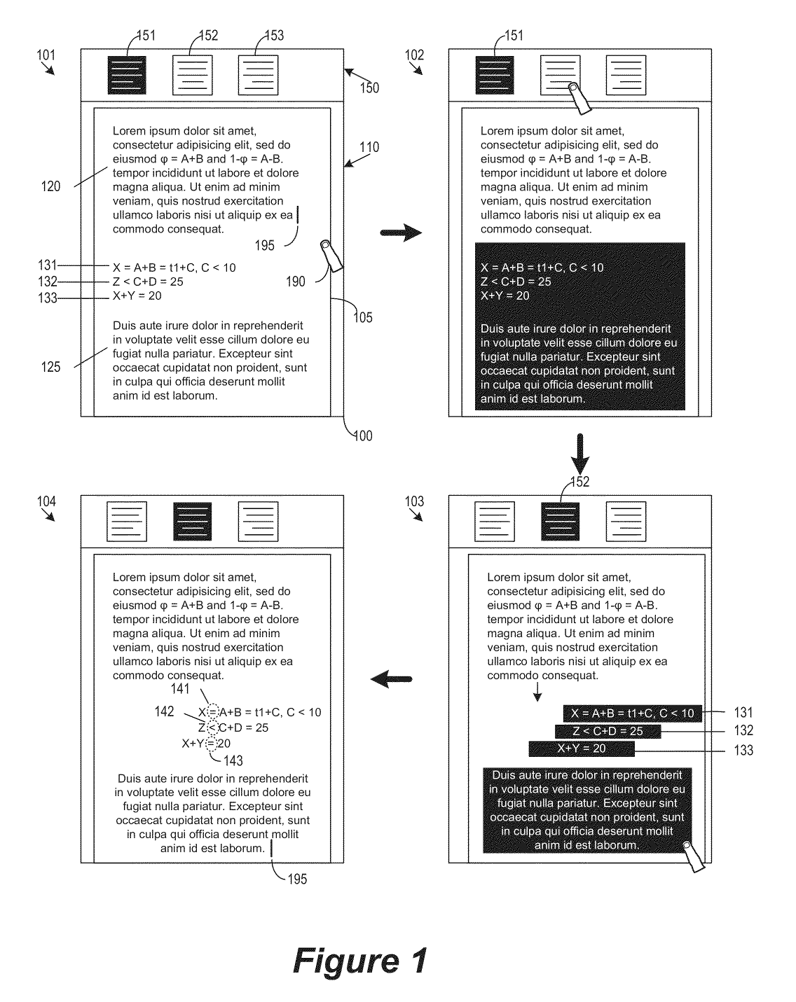

FIG. 1 illustrates a graphical user interface 100 of a content presentation editing application, in which mathematical objects, in response to a centering operation, are being aligned at their alignment symbol. A content presentation editing application is for editing content presentations or for authoring structured electronic documents such as e-books or electronic versions of print books. In some embodiments, a content presentation editing application can also be a word processor, a desktop publishing application, or some other types of applications. A content presentation editing application is also referred to as document authoring application in some embodiments.

The mathematical objects are within an electronic document 105. A centering operation is performed on a selected portion of the document. As illustrated, the GUI 100 includes a document area 110 and a menu area 150. The GUI 100 also displays a selection indicator 195. The action of the user is illustrated by a finger 190, which makes a selection within the GUI by touching the screen of the device that is running the content presentation editing application.

The menu area 150 includes various UI items that provide user access to various operations for the documents, operations such as saving the document, retrieving the document, printing the document, changing style settings for a part or the whole of the document, and other types of document related operations. In some embodiments, a UI item may also indicate a status regarding a particular setting.

As illustrated, the menu area 150 includes alignment UI items 151, 152, and 153. The UI item 151 is for aligning a selected portion of the text towards the left (left align). The UI item 153 is for aligning a selected portion of the text towards the right (right align). The UI item 152 is for aligning a selected portion of the text at the center (center align).

The document area 110 displays a portion or the whole of the document 105. In some embodiments, the document area 110 displays the portion of the document 105 in a window while displaying another portion of the document 105 or another document in one or more other windows (not shown). The user action 190 indicates the current position of the user's interaction with the application, while the selection indicator 195 indicates the position in the document that is selected for further edits such as entry of new characters, objects, or application of new settings or formats.

As illustrated, the displayed portion of the document 105 includes text objects 120 and 125 and a mathematical object 130. The mathematical objects 131-133 are situated between the text objects 120 and 125. Though not shown, the document 105 can also include other types of objects such as images, photographs, charts, etc. These other types of objects can also be displayed in the document area 110 as part of the document 105.

The textual objects 120 and 125 include texts that can be coded as ASCII, Unicode, or some other type of textual code. In some embodiments, the text object can also include formatting or style information such as font, size, underline, bold, and others. When a textual object is left-aligned, each line of the textual object starts at the left margin but does not necessarily end at the right margin. Conversely, when a textual object is right-aligned, each line of the textual object ends at the right margin but does not necessarily start at the left margin. When a textual object is center-aligned, each line of the textual object is aligned to the center such that the line is equally distanced from the right margin and from the left margin.

Each of the mathematical objects 131-133 includes mathematical symbols, expressions, or equations. A mathematical expression or equation can include numbers, algebraic variables, coefficients, constants, functions, vectors, matrices, operators, and other mathematical symbols.

Some operators are functional operators. A functional operator represents a mathematical operation such as addition, subtraction, multiplication, division, integration, differentiation. In some embodiments, a functional operator can have one or more arguments. A functional operator can take the form of a symbol such as ‘+’ or ‘÷’ that has one argument at each side of the operator. A functional operator can take the generic form of f(x, y, z . . . ), in which a name of the function is followed by a list of arguments (with or without parenthesis). A functional operator can also take an extended form that visually spans the width and/or height of multiple characters or symbols. Examples of operators in extended form include fractions, radicals, integrals, summations, products, etc. These operators can have one or more arguments at different positions of the mathematical objects.

Some operators have arguments that are nested mathematical expressions or equations. A nested mathematical expression or equation is a complete mathematical object in its self, but it is nested under another mathematical expression or equation as an argument. For example, the equation z=\sqrt{x+y} has the mathematical expression x+y nested under the radical √ as an argument to the square root operation. Some operators place some or all of their arguments in subscript or superscripts. Some operators in the extended form such as integral and summation often have some their arguments in superscript or subscript. For example, the expression

$${\sum }_{n = - ∞}^{∞} {x}_{1} ( n ) {x}_{2}^{*} ( n )$$

has the equation n=−∞ nested in a subscript as an argument to the summation operator.

Some operators are relational operators. A relational operator defines or expresses some kind of relationship between two entities or mathematical expressions. For example, the equal sign ‘=’ in the equation “x+y=20” states that the relationship between the mathematical expression “x+y” and the number ‘20’ is that “x+y” is equal to the number ‘20’, while the less-than sign ‘<’ in “Z<C+D” state that the relationship between the algebraic variable ‘Z’ and the mathematical expression “C+D” is that ‘Z’ is less than “C+D”. In addition to equalities and inequalities, some embodiments recognize other relational operators that express a relationship between two entities or mathematical expressions. These relational operators includes symbols such as ‘=’, ‘<’, ‘>’, ‘≠’, ‘≧’, ‘≦’, ‘→’, ‘≡’, ‘≈’, ‘ [symbol] ’, ‘∝’, ‘ε’, and many others.

Similar to a text object, a left-aligned mathematical object starts at the left margin but does not necessarily end at the right margin. Conversely, a right-aligned mathematical object ends at the right margin but does not necessarily start at the left margin. To center align a mathematical object, some embodiments handle mathematical objects differently from objects that are not mathematical objects (such as text objects). Specifically, some embodiments center align a mathematical object by first identifying an alignment symbol in the mathematical expression and then positioning the mathematical object such that the alignment symbol lines up with a particular position in the document. In some embodiments, this particular position is the center of the page that is equally distanced from the left margin and the right margin.

To handle the alignment operation of a mathematical object (such as 131) differently from other objects in the document 105 (such as the textual objects 120 and 125) requires that the mathematical objects 131-133 be identified as mathematical objects. In some embodiments, mathematical objects include markers that can be used to identify them as mathematical objects. In some embodiments, the mathematical objects are created by a math object editing tool, which in turn marks the object as a mathematical object or places the object in a data structure that is distinct from text, graphics, and other types of objects.

FIG. 1 illustrates the center alignment operation involving the mathematical objects 131-133 of the document 105 in four stages 101-104 of the GUI 100. At the first stage 101, the text objects 120 and 125 as well as the mathematical objects are not yet center aligned. The objects 120, 125, 131-133 are in fact all left-aligned. The left alignment UI item 151 in the menu area 150 is highlighted, indicating that the selection indicator 195 is at a position of the document that is currently left-aligned.

The second stage 102 shows the selection of a portion of the document 105. The selection includes the text object 125 and the mathematical objects 131-133. The selection starts from before the start of the mathematical object 131 and ends after the text object 125. In some embodiment, the selection is made by the user performing a click and drag operation by touching the screen of the device (as indicated by 190), which causes the selection indicator 195 to move to the start of the mathematical object 131 (the start the of the selection) and expand toward the end of the text object 125 (the end of the selection). The selected portion of the document 105 accordingly becomes highlighted. The left alignment UI item is also highlighted to indicate that the selected portion of the document is currently left aligned.

The second stage 102 also shows the selection of the center align operation. As illustrated, the user's action 190 is over the center alignment UI item 152, ready to select the UI item and apply center alignment operation to the selected portion of the document 105, which includes the mathematical objects 131-133 as well as the text object 125.

The third stage 103 shows the application of the center alignment to the selected portion of the document, which remains highlighted. The user has selected the center align UI item 152, making the center align UI item 152 highlighted while the left align UI item 151 is no longer highlighted. The text object 125 has become center aligned, and each line in the text object 125 is equally distanced from the left margin and the right margin. The mathematical objects 131-133 have also become “center aligned”, but not in a same way as the texts object 125. Specifically, each of the center aligned mathematical objects 131-133 is positioned according to an alignment symbol. The symbol 141 (an ‘=’ operator) is identified as the alignment symbol for the object 131. The symbol 142 (a ‘<’ operator) is identified as the alignment symbol for the object 132. The symbol 143 (an ‘=’ operator) is identified as the alignment symbol for the object 133. The mathematical objects 131-133 are aligned with each other at each mathematical object's alignment symbol.

The fourth stage 104 shows the completion of the center alignment operation. The text object 125 and the mathematical objects 131-133 are no longer highlighted, indicating that they are no longer selected. Instead, the selection indicator 195 appears to indicate the position in the document that is selected for further edits. The text object 120 remains left aligned as it was not selected for the center-alignment operation. The text object 125 is center aligned. The mathematical objects 131-133 are “center aligned” according to their identified alignment symbols.

Several more detailed embodiments of the invention are described below. Section I describes center-alignment operation involving mathematical objects in an electronic document. Section II describes in further detail the operation to identify alignment symbols for the purpose of center-aligning mathematical objects. Section III describes center-alignment mathematical objects that are in tables. Section IV describes software architecture of a document authoring application that performs center-alignment operations involving mathematical objects. Finally, Section V describes an electronic system with which some embodiments of the invention are implemented.

### I. Center-Aligning a Mathematical Object

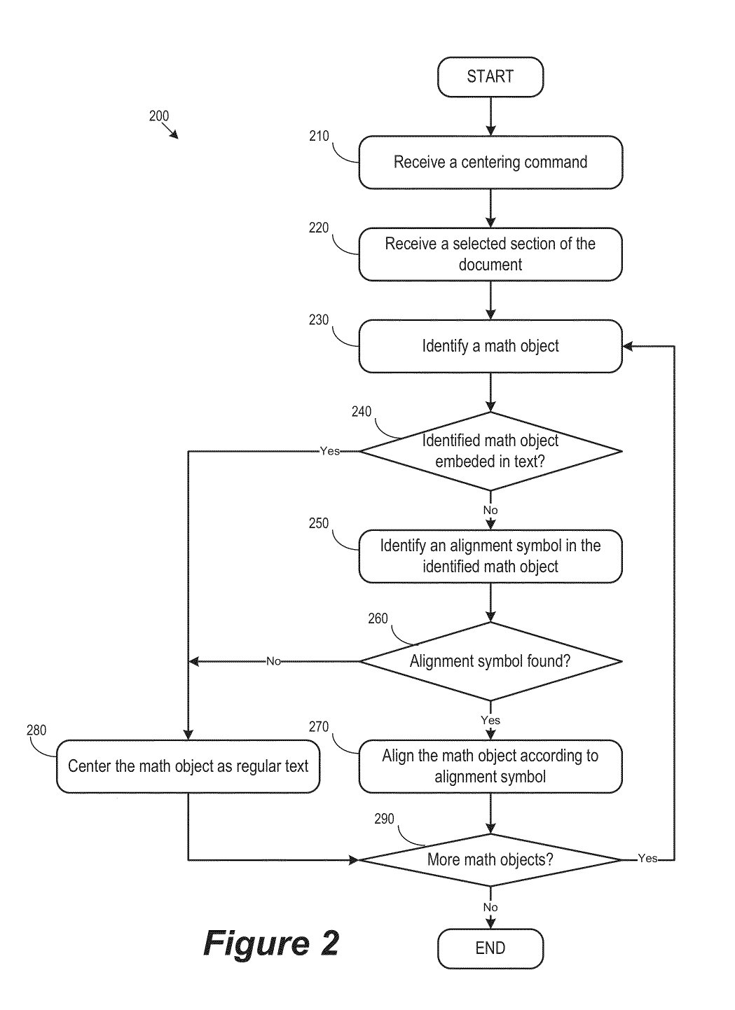

FIG. 1 above illustrates a content presentation editing application or a document authoring application that performs a center-alignment operation on a portion of an electronic document that includes mathematical objects. For some embodiments, FIG. 2 conceptually illustrates a process 200 that performs a center alignment operation for a selected portion of a document that includes a mathematical object. The process starts when it receives (at 210) a centering alignment command from the user. In some embodiments, this command is received as the result of the user selecting a center alignment UI item such as the UI item 152. In some embodiments, this center alignment operation takes place whenever the user is editing a mathematical object that is marked as being center aligned (such as the mathematical objects 131-133 after the stage 104). In some embodiments, this center alignment operation does not start until the content presentation editing application is formatting the authored document for publication (e.g., creating a PDF file or an eBook).

The process next receives (at 220) a selected section of the document. In some embodiments, the selection includes indications of the start of the selection as well as the end of the selection. In some embodiments, the selection can include multiple sections that are disjointed from each other and have multiple start point and end points. The selection can include different types of objects such as text and graphics, as well as one or more mathematical objects.

Next, the process identifies (at 230) a mathematical object from within the selection. In some embodiments, mathematical objects reside in a particular structure within the document and can be readily identified. In some embodiments, the mathematical objects are in data structures that are distinct from text, graphics, or other types of objects. In some embodiments, mathematical objects are marked by markers that identify them as mathematical objects. In some embodiments, the process scans the selection for patterns that possesses the characteristics of a mathematical expression, such as having mathematical symbols.

The process then determines (at 240) whether the identified mathematical object is embedded in text, or whether the mathematical object is the only object occupying its row or line in the document. If the identified mathematical object is embedded in text such as the mathematical expression 334, the process proceeds to 280 to center the mathematical object like regular text. Otherwise, if the identified mathematical expression is the only object in its line of the document, the process proceeds to 250.

In some embodiments, a mathematical object in a line of the document that also includes other types of objects will not be center-aligned based on an identified alignment symbol, but instead be center-aligned as any other type of object in the document. Specifically, a mathematical object embedded in a text object that is center aligned will be moved along as part of that text object such that the line of text will be equally distanced from both sides of the page. In some embodiments, the process would not perform identification of an alignment symbol for an embedded mathematical object.

At 250, the process identifies an alignment symbol in the identified mathematical object. To identify the alignment symbol, some embodiments uses a search tree associated with the mathematical object to search for a suitable symbol. Some embodiments construct such a tree by parsing the mathematical object when the process is performing the alignment operation on the mathematical object. In some other embodiments, such a search tree already exists prior to the alignment operation. For example, some embodiments represent each mathematical object as a searchable tree in the data structure of the electronic document.

Each leaf node of the search tree corresponds to a character in the mathematical object. The content presentation editing application identifies an alignment symbol from the search tree by traversing the search tree in a depth first manner. In some embodiments, the alignment symbol is a relational operator that is encountered before any other relational operator during the traversal of the search tree. Section II below will further describe identification of an alignment symbol in greater detail.

At 260, the process determines whether the alignment symbol has been found. If the process is able to find a suitable alignment symbol, the process proceeds to 270 to center align the mathematical object by using the alignment symbol, otherwise, the process proceeds to 280 to align the mathematical object as part of the regular text.

At 270, the process aligns the mathematical object by using the identified alignment symbol. In some embodiments, a mathematical object that has a symbol that has been identified as an alignment symbol will be moved horizontally to a particular position in the document. In some embodiments, this particular position is the center of the page that is equally distanced from the left margin and the right margin. If there are multiple mathematical objects within the selection with identified alignment symbol, they will all be aligned along their identified alignment symbols.

At 280, the process aligns the mathematical object like regular text. In some embodiments, a mathematical object will be center aligned like regular text if it shares a same line with other types object, or if no suitable alignment symbol can be found in the mathematical object. A mathematical object that is not aligned by an alignment symbol will be moved until the line in the document that includes the mathematical object is equally distanced from both the right margin and the left margin.

After either aligning the mathematical object by using its identified alignment symbol or by treating it as part of regular text, the process determines (at 290) whether there are more mathematical objects in the selection. If so, the process returns to 230 to identify and align the next mathematical object. If not, the process 200 ends.

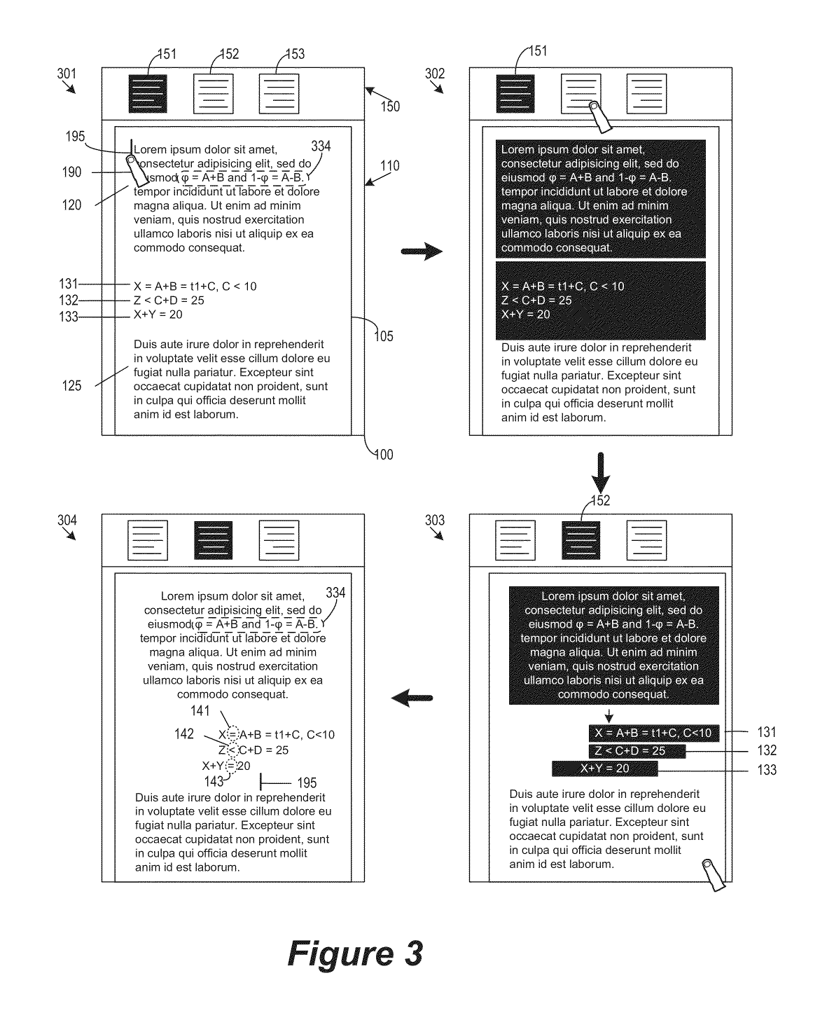

In the example illustrated above in FIG. 1, each of the center-aligned mathematical objects 131-133 is in a line by itself. However, some embodiments do not align a mathematical object by its alignment symbol if the mathematical object is in a same line with other objects that are not part of the mathematical object. For example, a mathematical object that is embedded in another object (such as in a line of regular text) will not be aligned by using the mathematical object's own alignment symbol. FIG. 3 illustrates the center alignment operation for a portion of a document that includes a mathematical object that is embedded in a text object.

FIG. 3 illustrates the center alignment operation in four stages 301-304 of the GUI 100. The first stage 301 shows the GUI before the center alignment operation, which is similar to the stage 101 of FIG. 1. The document window 110 is showing the portion of the document 105 that includes the text object 120, the mathematical objects 131-133, and the text object 125. The text object 120 includes an embedded mathematical expression 334.

The second stage 302 shows the selection of a portion of the document 105. The selection includes the mathematical objects 131-133 and the text object 120, which includes the embedded mathematical expression 334. The selected portion of the document 105 accordingly becomes highlighted. The left alignment UI item 151 is also highlighted to indicate that the selected portion of the document is currently left aligned. The second stage 102 also shows the selection of the center align operation as the user's action 190 is over the center alignment UI item 152.

The third stage 303 shows the application of the center alignment to the selected portion of the document, which remains highlighted. The user has selected the center align UI item 152, making the center align UI item 152 highlighted while the left align UI item 151 is no longer highlighted. The mathematical objects 131-133 have also become “center aligned” as they did in FIG. 1, namely the center aligned mathematical objects 131-133 are positioned according to the alignment symbol 141-143. The text object 120 has also become center aligned, and each line in the text object 120 is equally distanced from the left margin and the right margin. It is important to note that, although the mathematical express 334 is included in the selection to be center aligned, the line in the text object 120 that includes the mathematical expression 334 was not aligned according to an alignment symbol identified from the mathematical expression.

The fourth stage 304 shows the completion of the center alignment operation. The text object 120 and the mathematical objects 131-133 are no longer highlighted, indicating that they are no longer selected. Instead, the selection indicator 195 appears to indicate the position in the document that is selected for further edits. The text object 125 remains left aligned as it was not selected for the center-alignment operation. The mathematical objects 131-133 are “center aligned” according to their identified alignment symbols. The text object 120 is center aligned with each line being equal distanced from the left and right margins. The mathematical expression 334 is aligned as part of the text object 120.

### II. Identifying an Alignment Symbol

In order to align a mathematical object based on an alignment symbol in the mathematical object, an alignment symbol must first be identified. As mentioned above, a relational operator (such as ‘=’ or ‘>’) defines or expresses some kind of relationship between two entities or mathematical expressions. The relational operator of an equation is often the visual center of the equation. Some embodiments therefore identify a relational operator in a mathematical object as its alignment symbol.

To identify the alignment symbol, some embodiments use a search tree that is constructed by parsing the mathematical object. Each leaf node of the search tree corresponds to a stand-alone symbol in the mathematical object. A stand-alone symbol can be a single character (e.g., ‘5’, ‘×’, or ‘=’), a string of characters that is recognized as one symbol (e.g., “P₀” or “lim”), or other types of symbols. In some embodiments, such symbol can be a number, an operator (relational operator or functional operator), a variable, a parameter, a coefficient, a constant, or grammatical notations (such as comma, parenthesis, etc.). The content presentation editing application identifies the alignment symbol from the search tree by traversing the search tree in a depth first manner. In some embodiments, a relational operator that is encountered before any other relational operator during the traversal of the search tree is identified as the alignment symbol.

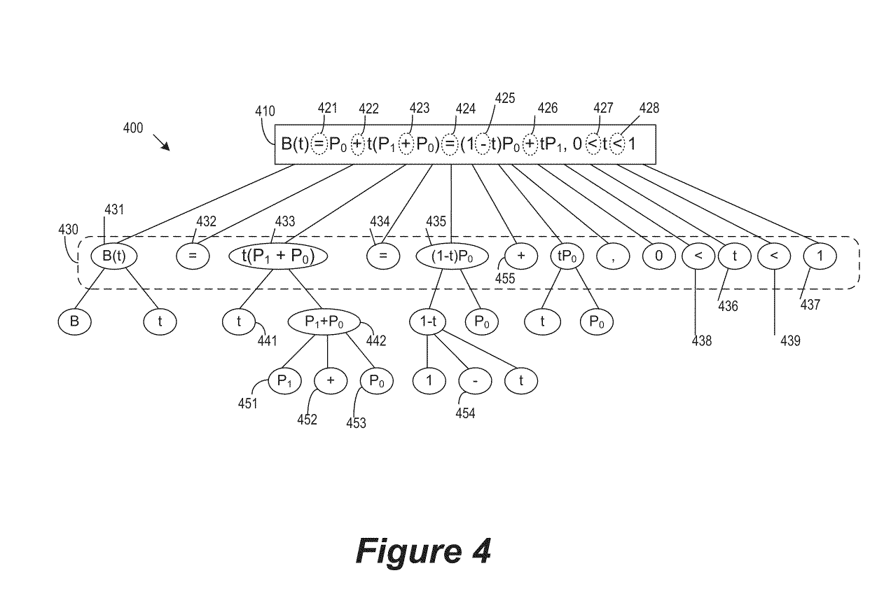

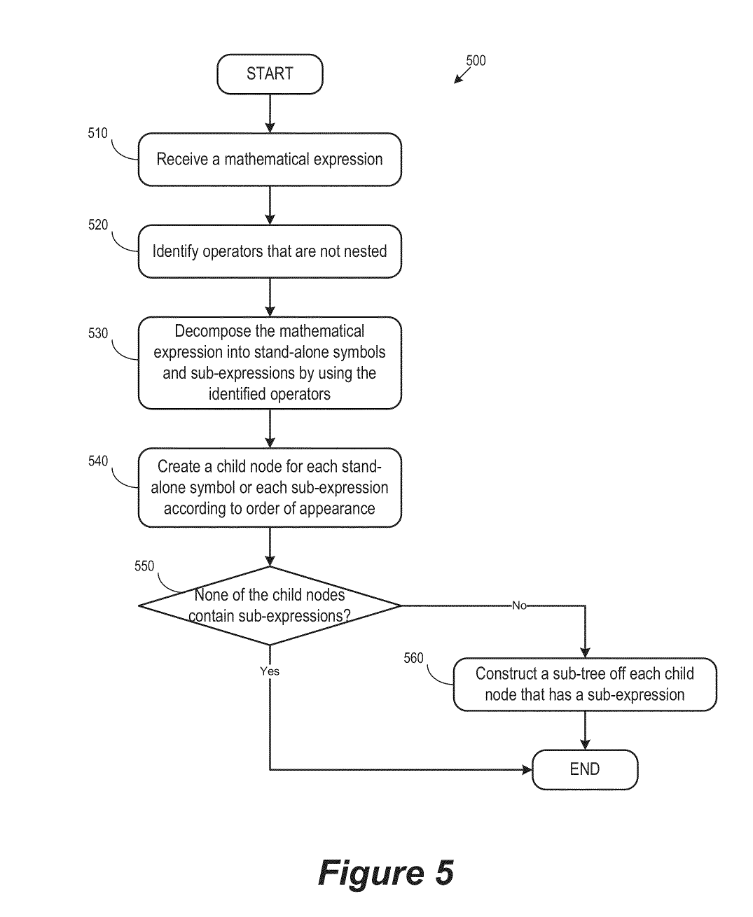

FIG. 4 illustrates a search tree 400 for identifying a relational operator for alignment from a mathematical expression 410. FIG. 4 will be described by reference to FIG. 5. As illustrated, a mathematical object 410 includes the following mathematical expression:

B(t)=P₀+t(P₁+P₀)=(1−t)P₀+tP₁,0<t<1

The search tree 400 is constructed by parsing the mathematical expression from the left to the right. In some embodiments, this search tree represents the mathematical expression as an object stored by a document authoring application. This mathematical object is stored within a stored representation of a document containing the mathematical expression 410.

For some embodiments, FIG. 5 conceptually illustrates a process 500 for constructing a search tree by parsing a mathematical expression such as the expression 410. The process 500 receives (at 510) a mathematical expression such as the expression 400, which includes a series of symbols. Some of the symbols are operators (e.g., ‘=’, ‘+’, ‘<’). Some of the symbols are alphanumeric (e.g., ‘1’, ‘P’). Some of the symbols are part of a sub-expression that nests two or more symbols. For example, some embodiments treats the product term t(P₁+P₀) as one sub-expression. (Some embodiments recognize the implied multiplication operator in the expression t(P₁+P₀) and treat it as one symbol ‘t’ and one sub-expression P₁+P₀). In some embodiments, the process 500 applies to symbols that are rendered as invisible or having a font color matching the background. (Some embodiments use invisible symbols to maintain centering in extended or multiple-line mathematical objects or equations.)

The process next identifies (at 520) operators that are not nested in the mathematical expression. The expression 410 includes 8 operators 421-428, some of which are nested operators. The ‘+’ operator 423 in the sub-expression (P₁+P₀) and the ‘−’ operator 425 in the sub-expression (1−t) are nested operators that lie within parenthesis. Other operators (421, 422, 424, 426, 427, and 428) in the expression 410 are not nested.

The process decomposes (530) the mathematical expression into stand-alone symbols and sub-expressions by using the identified operators. In other words, operators that are identified as not being nested within another expression are used as separators in breaking up the mathematical expression 410 into stand-alone symbols and sub-expressions.

After the decomposition, the process creates (540) a child node for each stand-alone symbol, each sub-expression, and each identified, non-nested operator according to their order of appearance in the mathematical object. In the example of FIG. 4, the expression 410 is decomposed into child nodes 430. Each of the child nodes is assigned one of the stand-alone symbols (e.g., the alphanumeric “t” and “1” in the child nodes 436 and 437), sub-expressions (e.g., “B(t)”, “(1−t)P₀” in the child nodes 431 and 435), or non-nested operators (e.g., the ‘=’ operator in the child node 432, or the ‘+’ operator in the child node 455). The assignment of the decomposed symbols and sub-expressions to child nodes is according to the order of appearance in the mathematical expression. In other words, the first child node created is assigned the first symbol or sub-expression that appear in the equation 400, and the second child node created is assigned the second symbol or sub-expression that appear in the equation 410, etc.

After the child nodes have been created, the process determines (at 550) whether any of the child nodes contain sub-expressions. If all of the child nodes contain only stand-alone symbols that do not need to be decomposed further, the process 500 ends. On the other hand, if any of the child nodes contains a sub-expression that needs to be decomposed further, the process proceeds to 560.

At 560, the process constructs a sub-tree off each child node that has a sub-expression. In other words, the process 500 recursively calls on itself to further decompose sub-expressions and create grand-child nodes and great-grand child nodes, etc. In the example of FIG. 4, the process 500 is recursively called to decompose the child node 433 into grand-child nodes 441 and 442, and then again to decompose the grand-child node 442 into great-grand child nodes 451-453. The great-grand child nodes 451-453 contain only stand-alone symbols so the process 500 will not be recursively called. After constructing a sub-tree for each sub-expression, the process 500 ends.

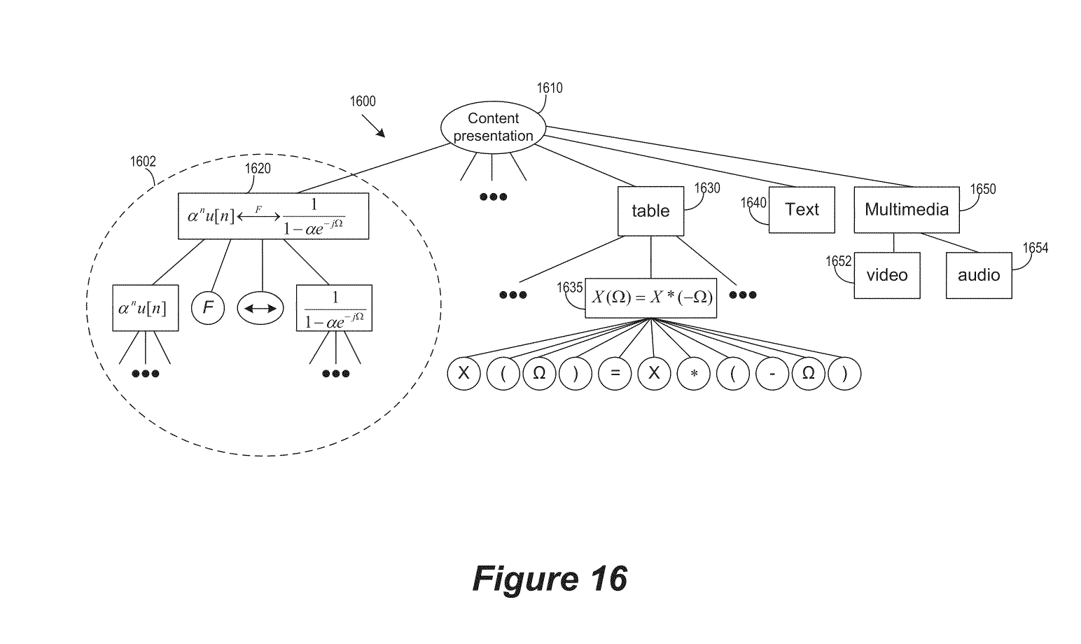

In some embodiments, a search tree, once constructed, is stored in memory so it is available for use by the content presentation editing application for future operations involving the mathematical object. In some embodiments, an operation on a mathematical object that requires the use of a search tree (such as an alignment operation) will not cause a new search tree to be constructed when a search tree is already available. In some embodiments, the search tree is stored in a hierarchical tree structure that links various objects into one electronic document or content presentation. An example of such a hierarchical tree structure will be further described below by reference to FIG. 16.

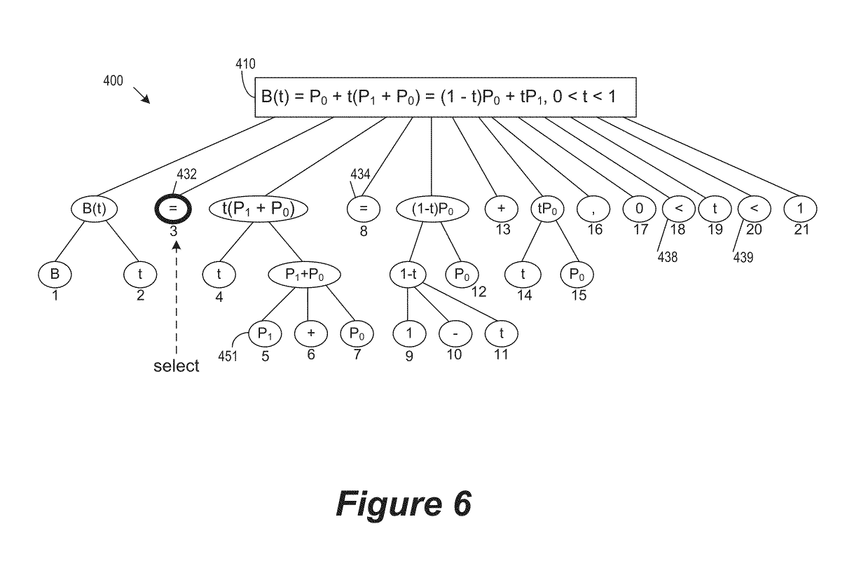

With the search tree 400 constructed, the alignment symbol for the mathematical expression 410 can be identified by traversing the constructed search tree. FIG. 6 illustrates the traversal of the search tree 400 for identifying a relational operator as the alignment symbol. As illustrated, the search tree is traversed in depth first manner, with nodes at the left traversed before nodes at the right. Leaf nodes (nodes without any child nodes) are identified and indexed according to the order that they are traversed. For example, the node 432 is the third leaf node traversed, and thus assigned an index of 3. The node 451 is the fifth node traversed, and thus assigned an index of 5.

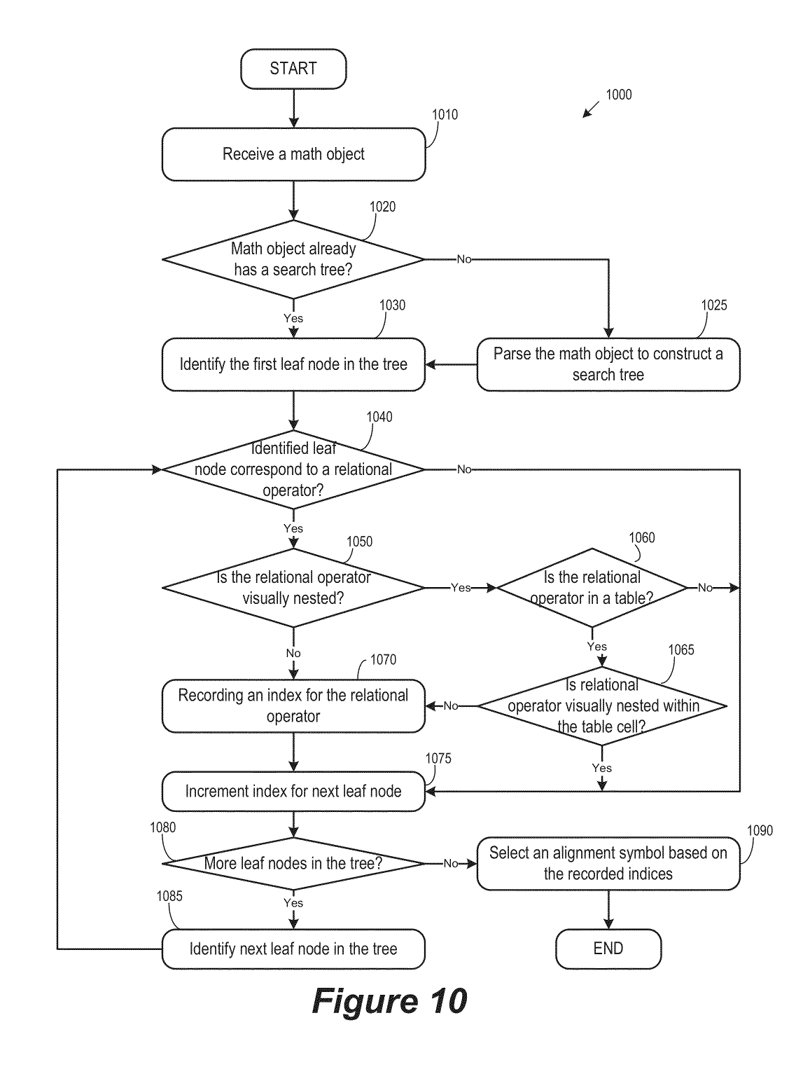

As mentioned, some embodiments identify the alignment symbol as the first relational operator encountered during the traversal of the search tree. In the example of FIG. 6, the leaf nodes 432 (‘=’), 434 (‘=’), 438 (‘<’), and 439 (‘<’) all contain relational operators. However, the relational operator in the leaf node 432 is indexed 3, while other leaf nodes hosting relational operators all have higher indexes because they are later traversed. Some embodiments therefore select the equal sign in the leaf node 432 as the alignment symbol. Operators that are not relational operators such as the addition operator ‘+’ in the leaf nodes 452 and 455 as well as the subtraction operator ‘−’ in the leaf node 454 are not eligible for selection as the alignment symbol in some embodiments, regardless of their order of traversal in the search tree and regardless of whether they are visually nested. A process for traversing the search tree and selecting the alignment symbol will be further described below by reference to FIG. 10.

Not all relational operators in mathematical objects are suitable as alignment symbols. Some relational operators are deeply nested or visually nested within a mathematical object and are therefore not likely to be the visual center of an equation. Some embodiments therefore would not select a deeply nested relational operator as the alignment symbol, even if that relational operator is the first one encountered in the search tree.

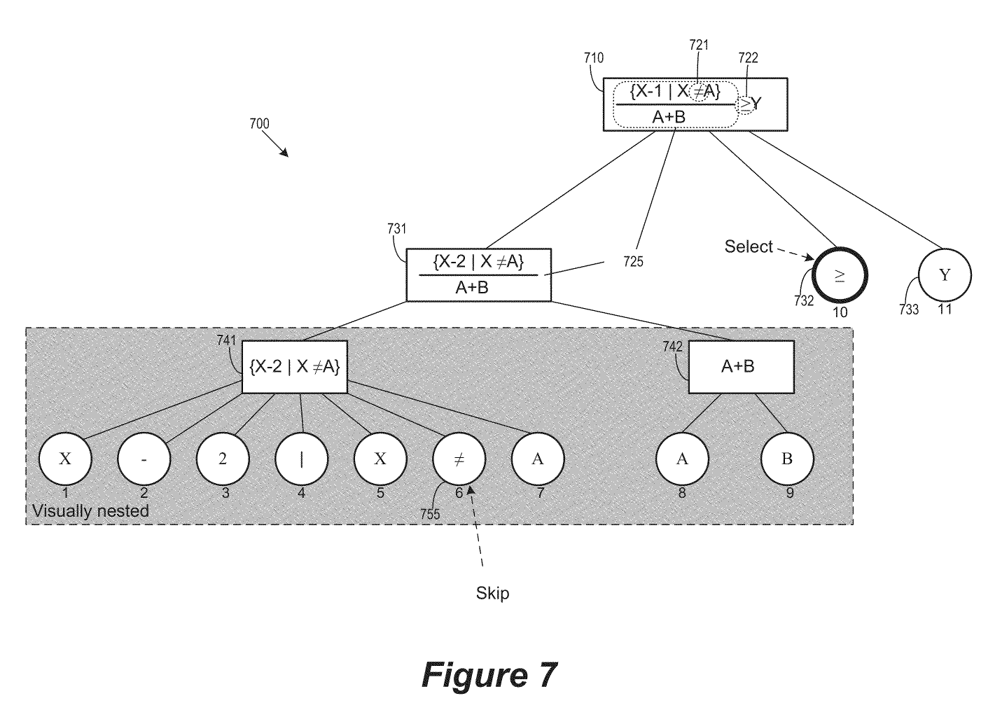

FIG. 7 illustrates the identification of an alignment symbol in a mathematical object that includes deeply nested relational operators. Specifically, FIG. 7 illustrates the identification of an alignment symbol from a mathematical object that includes a relational operator that is nested in a fraction.

FIG. 7 illustrates a search tree 700 that is constructed for the mathematical object 710, which contains a mathematical expression

$$\frac{\{ X - 1 \vert X \neq A \}}{A + B} \geq Y$$

This mathematical expression includes two relational operators, an inequality operator 721, and a larger or equal operator 722. The inequality sign 721 is nested in the numerator of the fraction 725. The fraction 725 includes a functional operator in extended form that visually spans the width and/or height of multiple characters. The inequality sign 721 is visually nested within the fraction 725.

The search tree 700 is constructed by a process similar to the process 500 of FIG. 5 in some embodiments The root node of the search tree 700 has three child nodes 731-733. The child node 732 and the node 733 contain stand-alone symbols “≧” and “Y” respectively. The child node 731 contains the fraction 725, which has a numerator and a denominator as its two arguments. The numerator of the fraction 725 is in a grand-child node 741 and the denominator of the fraction 725 is in a grand-child node 742. A great-grand-child node 755 descended from the child node 731 includes the relational operator “≠”. This relational operator in 755 is in the numerator of the fraction 725, and is visually nested within the fraction 725.

As illustrated, each leaf node is indexed according to the order that they are traversed. The relational operator “≠” in the leaf node 755 is indexed 6, while the relational operator “≧” in the leaf node 732 is indexed 10. However, since the relational operator “≠” in the leaf node 755 is visually nested within the fraction 725, some embodiments will not select it as the alignment symbol, but instead uses the relational operator “≧” in the leaf node 732 as the alignment operator. The relational operator in the leaf node 732 is selected because it is the earliest node traversed that is not visually nested.

In order to identify relational operators that are considered visually nested, some embodiments mark certain functional operators as having visually nested arguments. Leaf nodes that descend from these visually nested arguments are marked as being visually nested by these embodiments. Relational operators in those leaf nodes will be excluded from being identified or selected as the alignment symbol. In the example of FIG. 7, the fraction 725 is marked as having visually nested arguments. Hence symbols in leaf nodes that descend from either the numerator node 741 or the denominator node 742 are also considered visually nested.

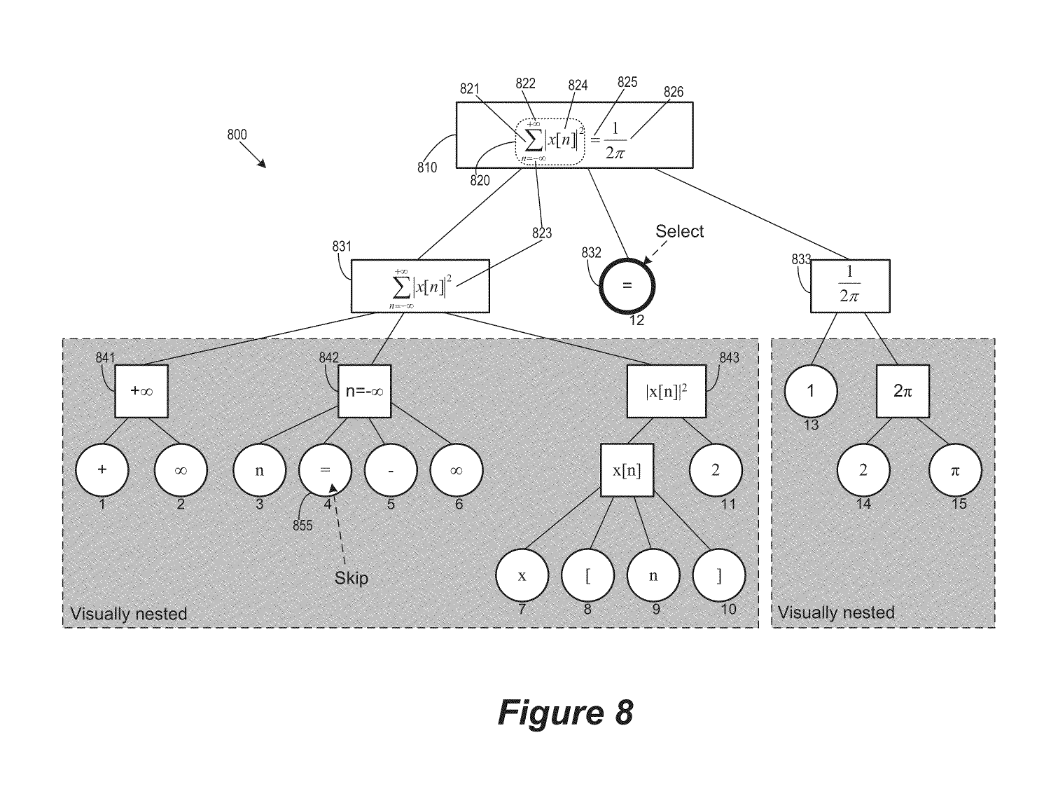

In some embodiments, a mathematical object can include several arguments in subscript or superscript form. Functional operators such as integration or summation often have mathematical expressions within these subscripts or superscripts. Symbols in these subscript or superscript are also considered deeply nested and therefore not eligible for selection as alignment symbols. FIG. 8 illustrates the identification of a relational operator as an alignment symbol when the mathematical objects include nested expressions in superscript or subscripts.

FIG. 8 illustrates a mathematical object 810 and a corresponding search tree 800. The mathematical object 810 contains the equation

$${\sum }_{n = - ∞}^{+ ∞} {\vert x [ n ] \vert}^{2} = \frac{1}{2 π}$$

which asserts that summation expression 820 is equal to the fraction 826. The summation expression 820 includes a summation operator 821, a superscript 822, a subscript 823, and a sequential term 824. The superscript 822, the subscript 823, and the sequential term 824 are the three arguments of the functional operator 820. The equation 810 includes one equal sign that is nested within the subscript 823 and another equal sign 825 that is not nested.

The search tree 800 is constructed by a process similar to the process 500 of FIG. 5 in some embodiments. The root node of the search tree 800 has three child nodes 831-833. The child node 831 contains the summation expression 820. The child node 832 contains the equal sign 825 as a stand-alone symbol. The child node 833 contains the fraction 826. Since both the child node 831 and 833 contain mathematical expressions with multiple arguments, they are decomposed further until leaf nodes are reached. The child node 831 has three offspring nodes 841-843 that corresponds to the three arguments of the summation expression 820. The node 841 contains the superscript 822, the node 842 contains the subscript 823, and the node 843 contains the sequential term 824. Each of the nodes 841-843 decomposes further into a number of leaf nodes. Among these, the leaf node 855 contains a relational operator ‘=’, which descended from the grand-child node 842 that contains the subscript 823 “n=−∞”.

Since the subscript 823 is visually nested beneath the summation operator 821, some embodiments mark the subscript 823 and all of its offspring nodes as also being visually nested. The relational operator in the leaf node 855 is therefore also marked as being visually nested. In some embodiments, the summation expression 820 and the fraction 826 are both regarded as having visually nested arguments, and hence all offspring nodes of nodes 831 and 833 are marked as being visually nested.

As illustrated, each leaf node is indexed according to the order that they are traversed. The relational operator “=” in the leaf node 855 is indexed 4, while the relational operator “=” in the leaf node 832 is indexed 12. However, since the relational operator “=” in the leaf node 855 is marked as being visually nested (for being an offspring of the visually nested node 842), some embodiments will not select it as the alignment symbol, but instead use the relational operator “=” in the leaf node 832 as the alignment operator. The relational operator in the leaf node 832 is selected as the alignment symbol because it is the earliest node traversed that is not visually nested.

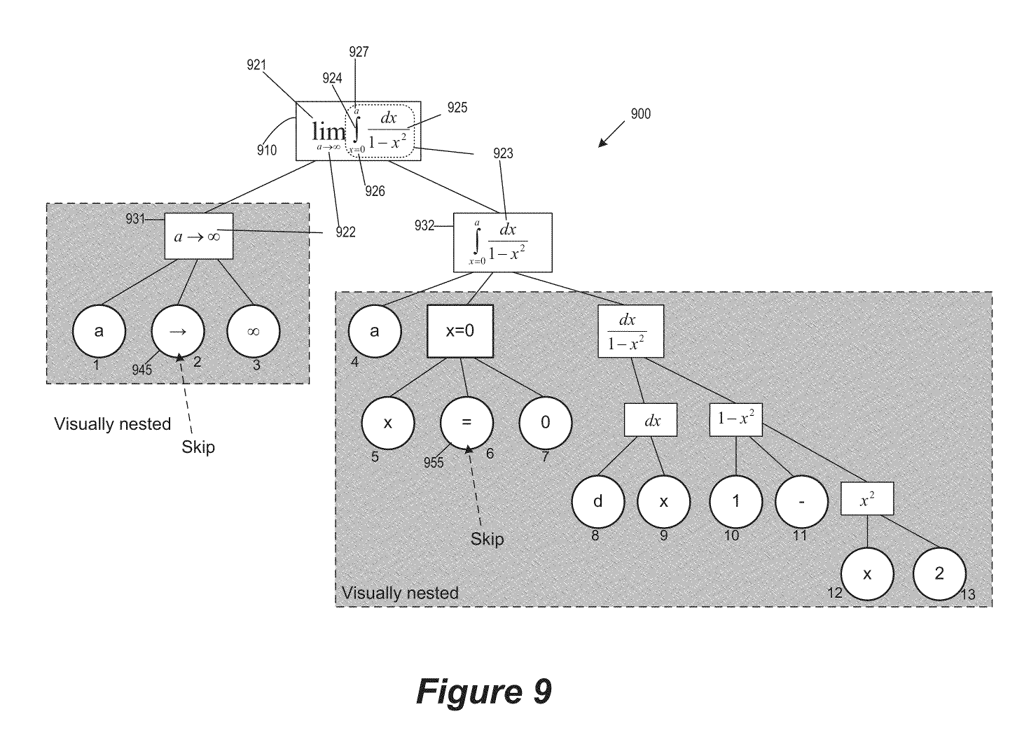

Not all mathematical objects that are selected to be center-aligned have at least one relational operator that is not visually nested. In some mathematical objects, all of the relational operators are visually nested and hence unsuitable as alignment symbols. FIG. 9 illustrates an example mathematical object in which all of the relational operators are visually nested.

FIG. 9 illustrates a mathematical object 910 and a corresponding search tree 900. The mathematical object 910 contains the mathematical expression

$${lim}_{a -> ∞} {\int }_{x = 0}^{a} \frac{d x}{1 - {x}^{2}}$$

which does not express a relationship between entities and is therefore not an equation. The expression 910 includes a limit operator 921, which has an approach term 922 and a functional term 923. The approach term 922 is in subscript form and includes a relational statement “a→∞”, which asserts that the relationship between ‘a’ and ‘∞’ is that ‘a’ is to approach ‘∞’. The functional term 923 is an integration expression that includes an integration operator 924, a functional term (which is a fraction) 925, an integration start in subscript 926 and an integration end in superscript 927. The subscript 926 includes a relational operator ‘=’ for stating that the integration starts when ‘x’ equals 0.

The search tree 900 is constructed by a process similar to the process 500 of FIG. 5 in some embodiments. The root node of the search tree 900 has two child nodes 931-932, corresponding to the two arguments of the limit operator 921. The child node 931 contains the subscript approach term 922. The child node 932 contains the functional term 923. Both child nodes 931-932 decompose further into a number of leaf nodes. Among these, the leaf node 945 contains the relational operator ‘→’, which descended from the child node 931 that contains the subscript 922 “a→∞”.

Since the subscript 922 is visually nested beneath the limit operator 921, some embodiments mark the subscript 922 and all of its offspring nodes as also being visually nested. The relational operator ‘→’ in the leaf node 945 is therefore also marked as being visually nested. Similarly, since the subscript 926 is visually nested beneath the integration operator 924, some embodiments mark the subscript 926 and all of its offspring nodes as also being visually nested. The relational operator ‘=’ in the leaf node 955 is therefore also marked as being visually nested. In some embodiments, all of the arguments of the integration operator are considered visually nested, and hence all of the offspring nodes of the child node 932 (which contains the integration term 923) are considered to be visually nested.

As illustrated, each leaf node is indexed according to the order that they are traversed. The relational operator ‘→’ in the leaf node 945 is indexed 2, while the relational operator “=” in the leaf node 955 is indexed 6. However, since both of these relational operators are visually nested, some embodiments consider neither of them to be eligible as alignment symbols. In these instances, some embodiments perform center alignment on the mathematical object as if they are any other object. Namely, the mathematical object 910 will be equally spaced from the left and right margins.

For some embodiments, FIG. 10 conceptually illustrates a process 1000 for identifying an alignment symbol from a search tree. In some embodiments, the process 1000 is used to identify the alignment symbol for the example discussed above in FIGS. 7-9. The process starts when the content presentation editing application has received a command to center-align a selection in the document that includes a mathematical object. The process receives (at 1010) the mathematical object and determines (at 1020) whether the mathematical object already has a search tree constructed for it. If yes, the process proceeds to 1030. If no, the process proceeds to 1025 and constructs a search tree by performing a process that is similar to the process 500 discussed above by reference to FIG. 5. The process 500 in some embodiments that stores each mathematical object as a searchable tree in the data structure does not perform the operation 1020 since a search tree for the mathematical object is always available.

Once the search tree has been constructed or has been determined to be available, the process identifies (at 1030) the first leaf node in the search tree. The process then determines (at 1040) if the identified leaf node corresponds to a relational operator. If the identified leaf node does not correspond to a relational operator, the process proceeds to 1075 to look for the next leaf node in the search tree. Otherwise, the process proceeds to 1050.

At 1050, the process determines whether the relational operator is visually nested. FIGS. 7-9 above describes several examples of determining whether a relational operator is visually nested. A relational operator that is not visually nested is considered eligible to be selected or identified as the alignment symbol. Some embodiments record an index associated with this leaf node to mark the leaf node as corresponding to an eligible relational operator. If the relational operator is not visually nested, the process 1000 proceeds to 1070 to record an index for the current leaf node/relational operator. If the relational operator is visually nested, the process proceeds to 1060.

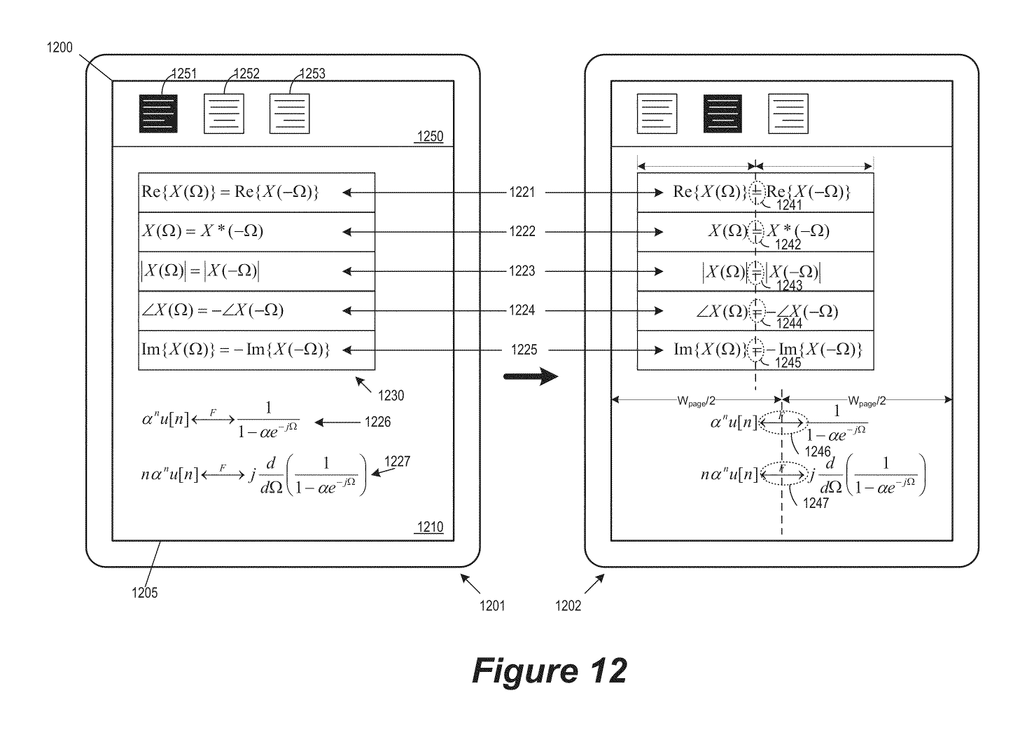

At 1060, the process determines whether the visually nested relational operator is in a table. In some embodiments, an equation within a table is considered nested and any operator or symbol within that equation is also considered nested. However, some of these relational operators are still suitable for aligning the equation within the table. If the visually nested operator is not in a table, the process proceeds to 1075 to examine the next leaf node. If the visually nested operator is in a table, the process proceeds to 1065. The handling of mathematical objects within tables will be further described below by reference to FIGS. 12-15.

At 1065, the process determines whether the relational operator in the leaf node is visually nested within the table. If a visually nested relational operator is considered visually nested only because it is in a table, then the relational operator can still be used to align the equation within the table. However, if the relational operator is visually nested within the table cell (i.e., one more level of nesting), the relational operator is not suitable for aligning the equation/mathematical object, even within the table cell. If the relational operator is visually nested within the table cell, the process proceeds to 1075 to examine the next leaf node. If the relational operator is not visually nested within the table cell, the process proceeds to 1070 to record an index for the current leaf node/relational operator.

The process records (at 1070) an index for the leaf cell that corresponds to the relational operator. The process next increments (at 1075) the index for the next leaf node. By incrementing the index, the process ensures that each leaf node is associated with a unique index that is indicative of when it was traversed in the search tree.

After incrementing the index, the process determines (at 1080) whether there are more leaf nodes in the tree. If so, the process proceeds to 1085 to traverse to the next leaf node in the search tree according to depth first search order. If not, the process proceeds to 1090.

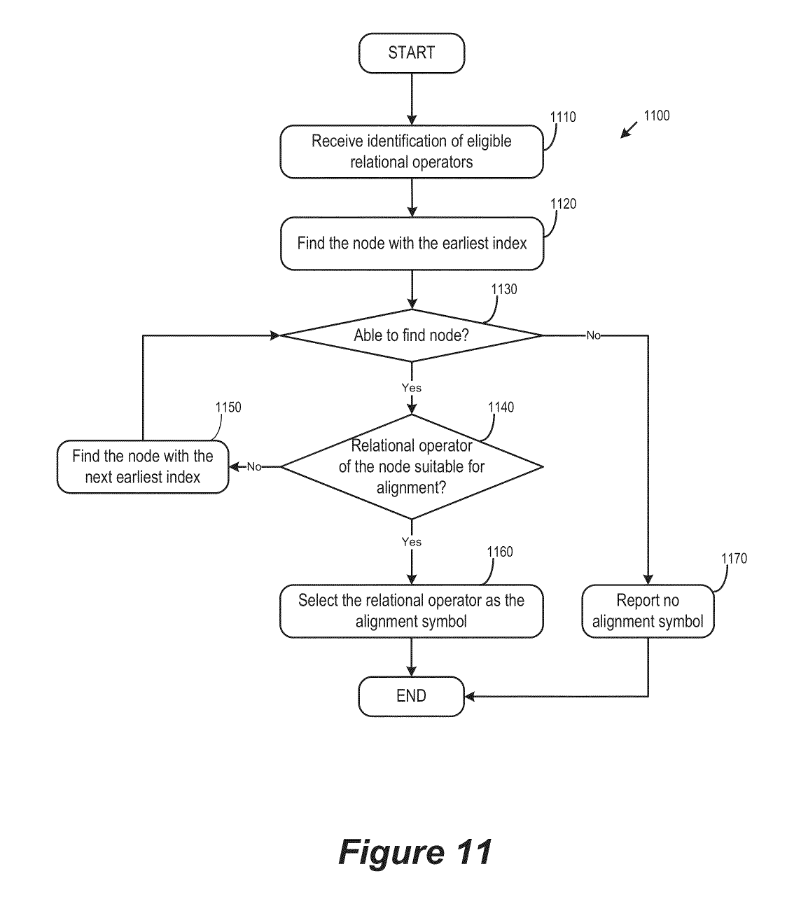

At 1090, the process selects an alignment symbol based on the recorded indices, which indicates which relational operators are eligible as alignment symbols (e.g., not visually nested). Using the recorded indices for selecting the alignment symbol excludes the visually nested relational operators from being considered as alignment symbols because the indices of their leaf nodes were not recorded by the process 1000. In some embodiments, the process selects the earliest relational operator that was encountered during the traversal of the search tree by identifying the leaf node with the earliest recorded index. A process for identifying an alignment symbol will be described below by reference to FIG. 11. One of ordinary skill would realize that indexing every leaf node is only one of many possible ways of identifying and recording eligible relational operators from the leaf nodes of the search tree. For example, instead of indexing leaf nodes during the traversal of the search tree, some embodiments create a linked list for eligible relational operators in the order they were encountered in the search tree.

After selecting the alignment symbol, the process 1000 ends.

FIG. 11 conceptually illustrates a process 1100 that is used by some embodiments to select or identify an alignment symbol from a group of eligible relational operators. In some embodiments, the process 1100 is performed during operation 1090 of the process 1000.

The process starts by receiving (at 1110) identification of eligible relational operators. In some embodiments, the eligible relational operators are identified by a traversal of the search tree that also excludes visually nested relational operators. In some embodiments, the identification of the eligible relational operators is provided as recorded indices of leaf nodes associated with the eligible relational operators, or as a linked list of those leaf nodes, or some other means of identification. The process then finds (at 1120) the node with the earliest index, i.e., the first node considered eligible as an alignment symbol encountered during the traversal of the search tree.

Next the process determines (at 1130) whether it is able to find an eligible relational operator, i.e., a node with a recorded index. If so, the process proceeds to 1140. Otherwise, the process 1100 proceeds to 1170 to report that there is no suitable alignment symbol.

At 1140, the process determines whether the relational operator of the node is suitable for alignment. Different embodiments make this determination differently. In some embodiments the process examines whether using the relational operator as an alignment symbol would cause the mathematical object to go off margin. In some embodiments, the process examines whether the type of the relational operator is likely to be the most important relationship in the mathematical object or equation. In some embodiments, the process always accepts the first eligible relational operator as suitable as the alignment symbol. If the relational operator is not suitable as an alignment symbol, the process proceeds to 1150 to find the next eligible relational operator. If the relational operator is suitable as an alignment symbol, the process 1100 proceeds to 1160 to select the relational operator as the alignment symbol.

After either selecting a relational operator as the alignment symbol or reporting that there is no alignment symbol, the process 1100 ends.

### III. Center Aligning Math Objects in Tables

As mentioned earlier, some mathematical objects are located within cells of a table. These mathematical objects, though considered as visually nested by some embodiments, are nevertheless suitable for being aligned by using an identified alignment symbol. FIG. 12 illustrates the alignment of equations that are within cells of tables.

FIG. 12 illustrates a center alignment operation for mathematical objects within a table in a GUI 1200. The center alignment operation is based on the identified relational operators in the mathematical objects. The center alignment operation moves each math object in the table such that the identified alignment symbol lines up with the center of the table column that contains the mathematical object.

The GUI 1200 includes a menu area 1250 and a document area 1210. The menu area 1250 includes alignment UI items 1251, 1252, and 1253 for aligning a selected portion of the text towards the left (left align), towards the right (right align), and at the center (center align) respectively. The document area 1210 is displaying a portion of a document 1205, which includes mathematical objects 1221-1227. Each of the objects 1221-1225 is in a cell of a table 1230, while the objects 1226 and 1227 are not within any table.

FIG. 12 illustrates the center alignment operation in two stages 1201 and 1202 of the GUI 1200. The first stage 1201 shows the GUI before the center alignment operation. The left-align UI item 1251 is highlighted. All of the mathematical objects 1221-1227 are left-aligned.

The second stage 1202 shows the GUI 1200 after the center alignment operation. The relational operators 1241-1247 have been identified as alignment symbols for the mathematical objects 1221-1227 respectively. The mathematical objects 1221-1225, which are located in the table 1230, are aligned such that the alignment symbols 1241-1245 are at the center of the table 1230 (since the table 1230 has only one column). The mathematical objects 1226-1227, which are not located in a table, are aligned such that the alignment symbols 1246-1247 are at the center of the document 1205 (i.e., the alignment symbol is equally spaced from the right and left margins of the page).

The relational operators 1241-1245 are in equations that are inside the table 1230. Though the equations in tables are considered as visually nested in some embodiments, relational operators that are not visually nested within a cell are not excluded from consideration as alignment symbols. However, if a relational operator is visually nested within a table cell, it will be excluded from consideration as alignment symbols by some embodiments.

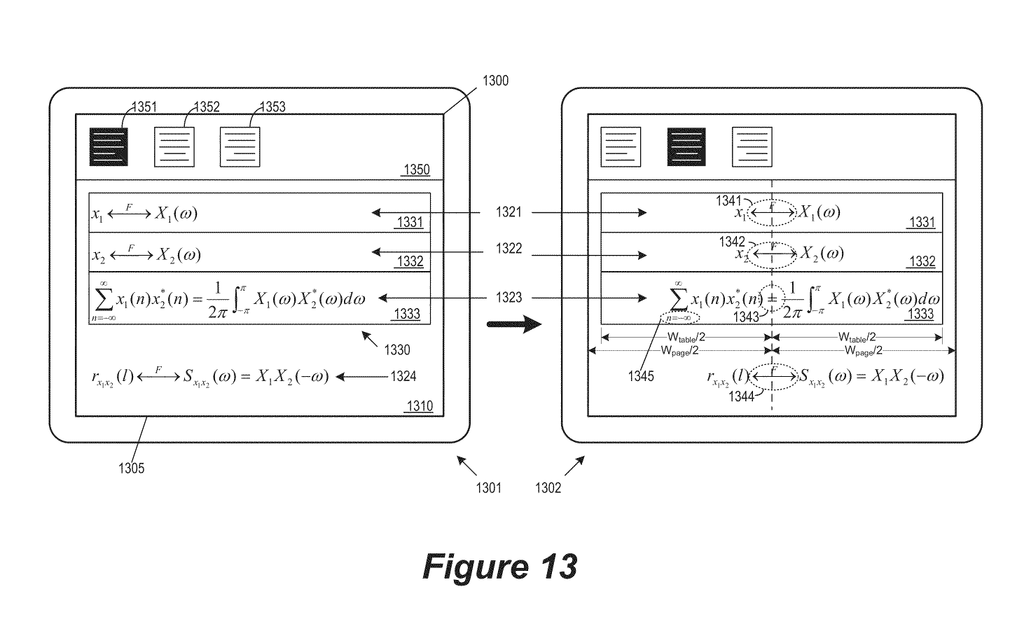

FIG. 13 illustrates the exclusion of a relational operator from consideration as an alignment symbol for an equation within a table. FIG. 13 illustrates a GUI 1300 that is similar to the GUI 1200, which includes a menu area 1350 and a document area 1310. The menu area 1350 includes alignment UI items 1351, 1352, and 1353 for left-align, right-align, and center-align respectively. The document area 1310 is displaying a portion of a document 1305, which includes mathematical objects 1321-1324. The objects 1321-1323 are in a table 1330, while the object 1324 is not within any table. The table 1330 includes cells 1331-1333, which contains the mathematical objects 1321-1323, respectively.

FIG. 13 illustrates the center alignment operation in two stages 1301 and 1302 of the GUI 1300. The first stage 1301 shows the GUI 1300 before the center alignment operation. The left-align UI item 1351 is highlighted. All of the mathematical objects 1321-1324 are left-aligned.

The second stage 1302 shows the GUI 1300 after the center alignment operation. The relational operators 1341-1344 have been identified as alignment symbols for the mathematical objects 1321-1324, respectively. The mathematical objects 1321-1323, which are located in the table 1330, are aligned such that the alignment symbols 1341-1343 are at the center of the table 1330 (since the table 1330 has only one column). The mathematical object 1324, which is not located in a table, is aligned such that the alignment symbol 1344 is at the center of the document 1305 (i.e., the alignment symbol is equally spaced from the right and left margins of the page).

The relational operator 1345 is nested within a subscript of a summation operator of the mathematical object 1323. It is therefore a visually nested relational operator within the cell 1333 of the table 1330. Although the traversal of the search tree of the mathematical object 1323 would encounter the relational operator 1345 before the relational operator 1343, the relational operator 1345 will not be considered eligible as an alignment symbol (because the relational operator 1345 is nested within a subscript of a summation operator, and hence visually nested within the cell 1333). The center-align operation of the equation 1323 is therefore performed based on the relational operator 1343 rather than the relational operator 1345.

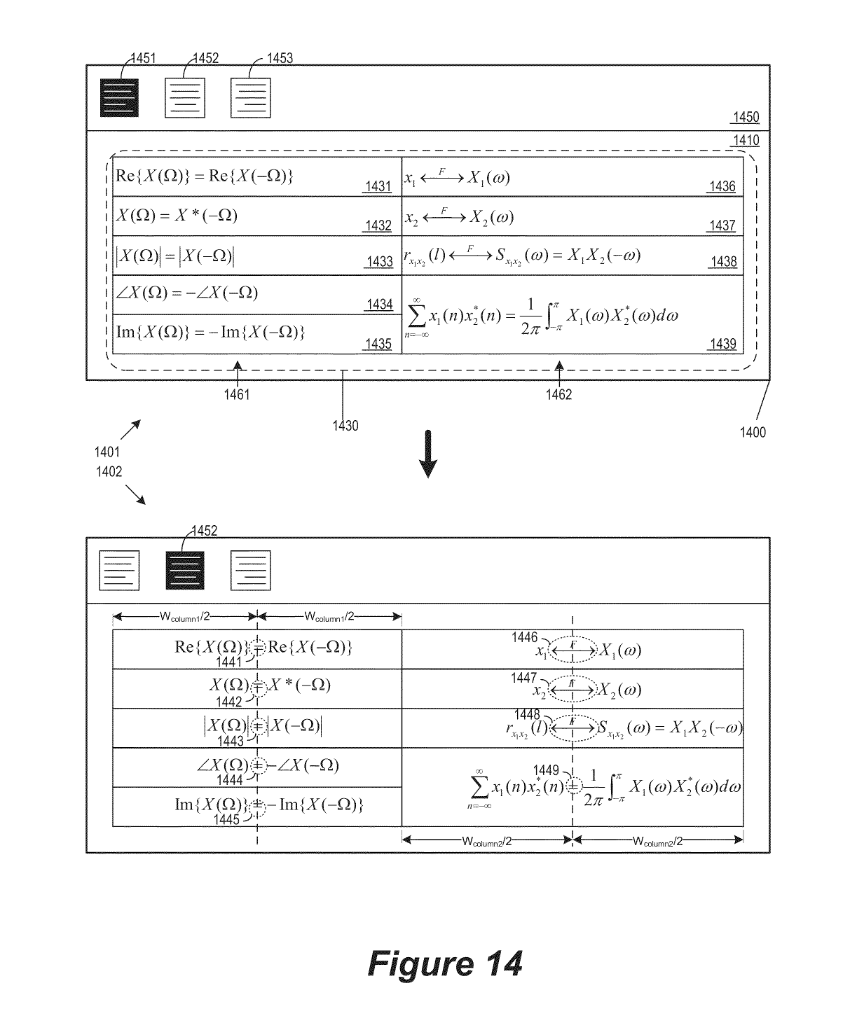

As discussed above, each mathematical object in a table is aligned to the center of the cell that contains the mathematical object. This is true for mathematical objects in tables with multiple columns as well. FIG. 14 illustrates a center-align operation for mathematical objects in multiple columns of a table.

FIG. 14 illustrates a GUI 1400 that is similar to the GUI 1200, which includes a menu area 1450 and a document area 1410. The menu area 1450 includes alignment UI items 1451, 1452, and 1453 for left-align, right-align, and center-align respectively. The document area 1410 is displaying a portion of a document that includes a table 1430. The table 1430 includes two columns 1461 and 1462. The column 1461 includes cells 1431-1435. The column 1462 includes cells 1436-1439. Each of cells 1431-1439 contains a mathematical object.

FIG. 14 illustrates the center alignment operation in two stages 1401 and 1402 of the GUI 1400. The first stage 1401 shows the GUI 1400 before the center alignment operation. The left-align UI item 1451 is highlighted. All of the mathematical objects in cells 1431-1439 (i.e., columns 1461 and 1462) are left-aligned.

The second stage 1402 shows the GUI 1400 after the center alignment operation. The relational operators 1441-1449 have been identified as alignment symbols for the mathematical objects in cells 1431-1439, respectively. The mathematical objects in cells 1431-1435, which are located in the table column 1461, are aligned such that the alignment symbols 1441-1445 are at the center of the column 1461. The mathematical objects in cells 1436-1439, which are located in the table column 1462, are aligned such that the alignment symbols 1446-1449 are at the center of the column 1462.

One of ordinary skill would understand that the example mathematical objects illustrated in FIGS. 1, 3, 4, 6-9, and 12-14 are for the purpose of aiding understanding. Operators in a mathematical object can be disqualified as alignment symbol because they are nested or because they are not relational operators or both. These examples do not define a complete or exclusive list of symbols that are used as relational operators by some embodiments.

### IV. Document Authoring Application

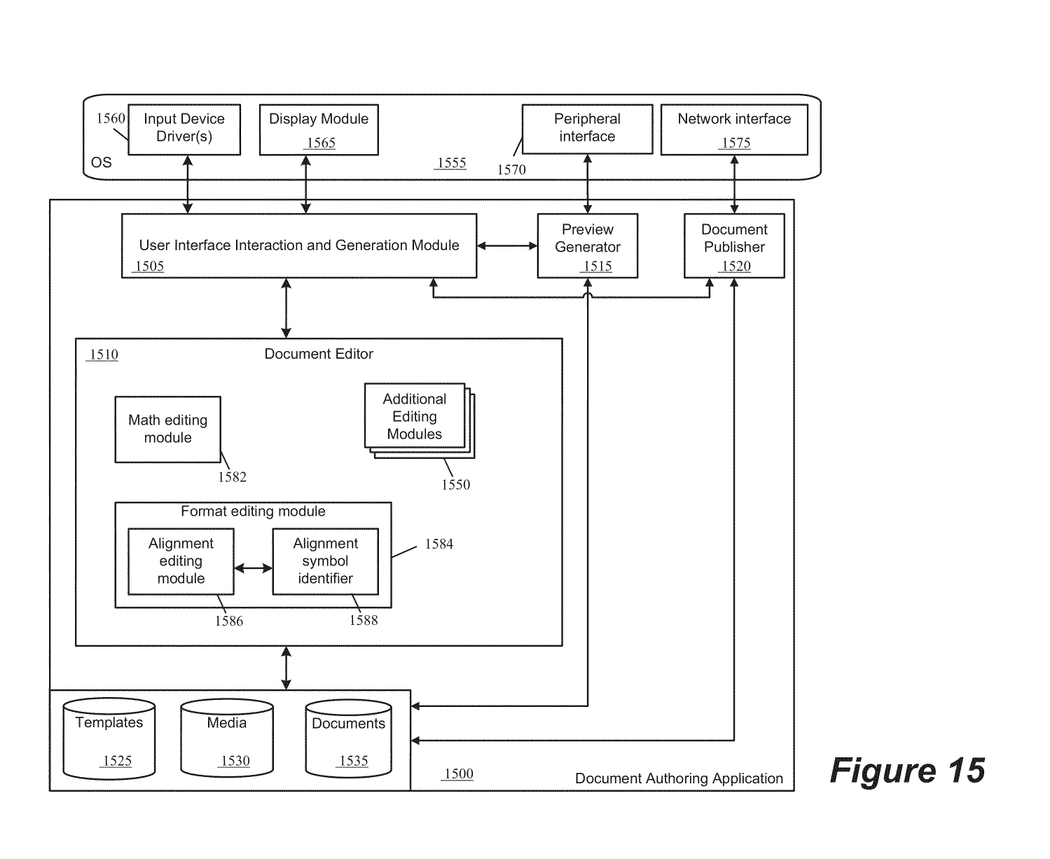

In some embodiments, the processes described above are implemented as software running on a particular machine, such as a computer or a handheld device, or stored in a machine-readable medium. FIG. 15 conceptually illustrates the software architecture of a document authoring application 1500 (or content presentation editing application) of some embodiments. In some embodiments, the document authoring application is a stand-alone application or is integrated into another application, while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The document authoring application 1500 includes a user interface (UI) interaction and generation module 1505, a document editor 1510, a preview generator 1515, and a document publisher 1520. The figure also illustrates stored data associated with the document authoring application, including templates 1525, media 1530, and documents 1535.

In some embodiments, the templates data 1525 stores template files that define different types of documents a user can create with the document authoring application 1500. The media data 1530 stores various types of media files (e.g., still image files, video files, audio files, combined video and audio files, etc.) imported into the application. The documents data 1535 of some embodiments stores user-created documents that may incorporate or refer to media 1530 and templates 1525. In some embodiments, the documents 1535 are stored by the document authoring application as hierarchical structures (e.g., organized into chapters, sections, etc.). In some embodiments, mathematical objects are stored as part of the hierarchical structure.

In some embodiments, the three sets of data 1525, 1530, and 1535 are stored in one physical storage (e.g., an internal hard drive, external hard drive, etc.). In some embodiments, the data may be split between multiple physical storages. For instance, the template files 1525 and media files 1530 might be stored in one physical storage, while the user-created documents are stored in a separate physical storage. In addition, some or all of the data 1525-1535 may be stored across multiple physical storages in some embodiments.

FIG. 15 also illustrates an operating system 1555 that includes input device driver(s) 1560, display module 1565, peripheral interface 1570, and network interface 1575. In some embodiments, as illustrated, the device drivers 1560, display module 1565, peripheral interface 1570, and network interface 1575 are part of the operating system even when the document authoring application 1500 is an application separate from the operating system.

The input device drivers 1560 may include drivers for translating signals from a keyboard, mouse, touchpad, tablet, touchscreen, etc. A user interacts with one or more of these input devices, which send signals to their corresponding device driver. The device driver then translates the signals into user input data that is provided to the UI interaction and generation module 1505.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc.). For example, the present application illustrates the use of a cursor in the graphical user interface to control (e.g., select, move) objects in the graphical user interface. However, in some embodiments, objects in the graphical user interface can also be controlled or manipulated through other controls, such as touch control. In some embodiments, touch control is implemented through an input device that can detect the presence and location of touch on a display of the device. An example of such a device is a touch screen device. In some embodiments, with touch control, a user can directly manipulate objects by interacting with the graphical user interface that is displayed on the display of the touch screen device. For instance, a user can select a particular object in the graphical user interface by simply touching that particular object on the display of the touch screen device. As such, when touch control is utilized, a cursor may not even be provided for enabling selection of an object of a graphical user interface in some embodiments. However, when a cursor is provided in a graphical user interface, touch control can be used to control the cursor in some embodiments.

The display module 1565 translates the output of a user interface for a display device. That is, the display module 1565 receives signals (e.g., from the UI interaction and generation module 1505) describing what should be displayed and translates these signals into pixel information that is sent to the display device. The display device may be an LCD, plasma screen, CRT monitor, touchscreen, etc.

The peripheral 1570, in some embodiments, allows for a peripheral device to connect (either via a wired (e.g., USB, Firewire) connection or a wireless (e.g., Bluetooth, WiFi) connection) to the machine on which the operating system 1555 and document authoring application 1500 run. Examples of such peripheral devices may include smart phones (e.g., an iPhone), specialized electronic book readers, or more generic tablets (e.g., an iPad) that include electronic book reader functionality.

The network interface 1575 represents one or more connections to various types of networks, through which the document authoring application 1500 may upload published documents (e.g., to a content distribution system). These network connections may include WiFi or other wireless connections, Ethernet or other wired connections, etc.

The UI interaction and generation module 1505 of the document authoring application 1500 interprets the user input data received from the input device drivers and passes it to various modules, including the document editor 1510 and its various component modules, the preview generator 1515, and the document publisher 1520. The UI interaction module also manages the display of the document authoring application GUI, and outputs this display information to the display module 1565. This UI display information may be based on information from the document editor 1510, the document publisher 1520, etc. In addition, the module 1505 may generate portions of the UI based solely on user input—e.g., when a user moves an item in the UI that only affects the display rather than any of the other modules, such as moving a window from one side of the UI to the other. In some embodiments, the UI interaction and generation module 1505 generates a basic GUI and populates the GUI with information from the other modules and stored data (e.g., the document data 1535).

The document editor 1510 includes math editing module 1582, format editing module 1584, alignment editing module 1586, alignment symbol identifier module 1588, as well as additional editing modules 1550. The document editor 1510 enables a user to create documents (e.g., word processing documents, electronic books, etc.) with a variety of text, equations, media (e.g., audio, video), electronic book constructs (e.g., graphs, sidebars, popovers, etc.), and other features.

The math editing module 1582 controls the editing operations of mathematical objects in the electronic document. Editing operations of a mathematical object include inserting, deletion, and modification of mathematical symbols and operators in the mathematical object. In some embodiments, the math editing module creates and edits mathematical objects in specialized data structures for mathematical objects. The mathematical objects are stored as part of the document data 1535. In some embodiments, the mathematical object created and edited by the math editing module 1582 can be used as the search tree for identifying an alignment operator.

The alignment editing module 1586 controls the alignment of various objects in the electronic document or content presentation, such moving a mathematical object so that the mathematical object's alignment symbol aligns with the center of a page or a table cell. The alignment symbol identifier 1588 identifies the alignment symbol of a given mathematical object. In some embodiments, the alignment symbol identifier 1588 identifies the alignment symbol in the mathematical object by searching and traversing the hierarchical tree structure of the document. Once an alignment symbol has been identified by the alignment symbol identifier 1588, the alignment editing module can use the identified symbol to perform center-alignment operation on the mathematical object.

The format editing module 1584 controls the formatting of the electronic document or content presentation. In some embodiments, the formatting of the content includes operations that change the fonts of text, size and position of various objects, (text, math, graphics, media, etc.,) alignment of objects and other operations that determine the appearance of the content presentation or electronic document. In some embodiments, the format editing module 1584 uses the alignment editing module 1586 and the alignment symbol identifier 1588 when performing alignment of objects in the document and/or formatting of mathematical objects.

In some embodiments, in order to perform a center alignment operation of a mathematical object, the format editing module 1584 performs processes similar to those described above by reference to FIGS. 2, 10, 11. In some of these embodiments, the format editing module 1584 also creates the search tree using a process similar to the process 500 as described above by reference to FIG. 5.

The additional editing modules 1550 enable various additional editing features. These features include formatting of electronic documents, addition of media and other constructs (e.g., graphs, sidebars, popovers, etc.) to electronic documents, spellchecking and other review features, etc.

The preview generator 1515 of some embodiments generates a preview of an electronic document (e.g., an electronic book) in order to allow a user to see how a document currently being edited will look in its final form, including mathematical objects that have been created, edited, or aligned. In some embodiments, the preview generator 1515 generates the preview of the document and sends this preview through the peripheral interface 1570 to an external electronic document reader device (e.g., a smart phone, a table computer, a specialized e-book reader, etc.). In addition, in some embodiments the document authoring application 1500 allows the user to preview the document through the application's user interface. The preview generator of some such embodiments can send the preview to the UI interaction and generation module 1505 for display in the authoring application user interface.

The document publisher 1520 of some embodiments generates a final version of an electronic document (e.g., an e-book in either a standardized or proprietary format) for sending out (e.g., via the network interface 1575) to a content distribution system. In some embodiments, the document publisher 1520 creates the electronic document and/or a sample version of the electronic document, and a separate application connects to the content distribution system in order to upload (publish) the document.

While many of the features of document authoring application 1500 have been described as being performed by one module (e.g., the UI interaction and generation module 1505, the document publisher 1520, etc.), one of ordinary skill in the art will recognize that the functions described herein might be split up into multiple modules. Similarly, functions described as being performed by multiple different modules might be performed by a single module in some embodiments (e.g., the alignment editing module 1586 and the alignment symbol identifier 1588 may actually be part of the format editing module 1584).

For some embodiments, FIG. 16 illustrates a data structure 1600 of a content presentation or a structured electronic document 1610 that can be authored or edited by a document authoring application or content presentation editing application such as 1500. As illustrated, the content presentation 1610 sits at the root node of the hierarchical tree structure 1600. The immediate child nodes of the content presentation 1610 include a mathematical object 1620, a table 1630, a text object 1640, and a multimedia object 1650 that has a video child node 1652 and an audio child node 1654. These child nodes represent different top level component objects of the electronic document.

Though not explicitly illustrated in the figure, the content presentation 1610 can include multiple objects of a same type as different nodes of the tree 1600. For example, there can be other mathematical object child nodes in addition to the mathematical child node 1620.

The mathematical object 1620 is the root of a sub-tree 1602. The nodes of the sub-tree 1602 include stand-alone symbols and sub-expressions that are broken down further into stand-alone symbols. In some embodiments, the sub-tree 1602 is used as the search tree for locating the alignment symbol of the mathematical object 1620.

The table object 1630 can include multiple objects of different types in each of its cells, where each object is represented by an offspring node of the table object 1630. One of the child nodes of the table object 1630 is a mathematical object 1635, which in some embodiments is also represented by a tree structure of stand-alone symbols and sub-expressions.

### V. Electronic System

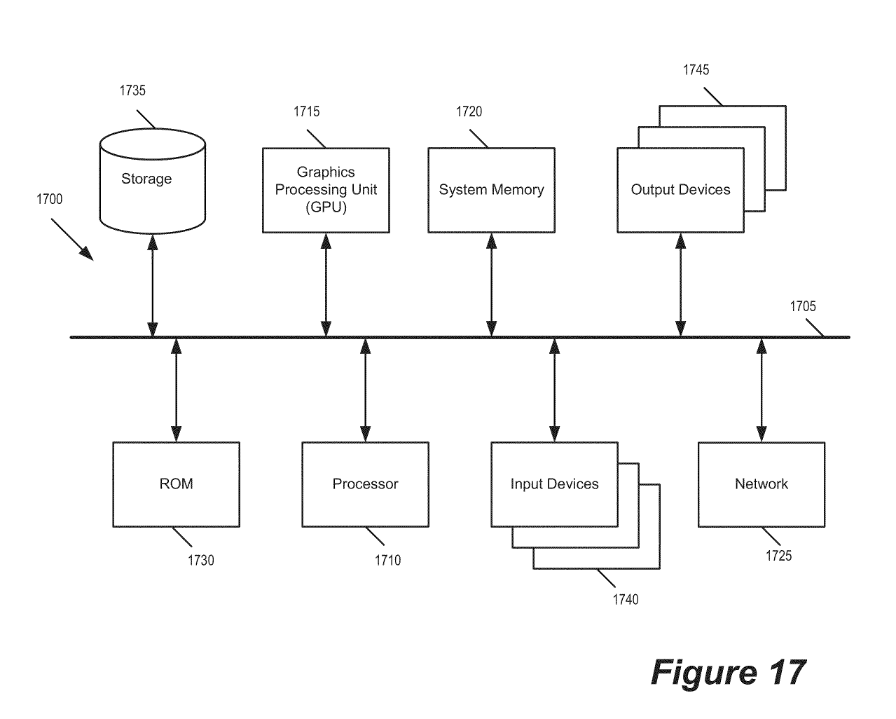

FIG. 17 conceptually illustrates an electronic system 1700 with which some embodiments of the invention are implemented. The electronic system 1700 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1700 includes a bus 1705, processing unit(s) 1710, a graphics processing unit (GPU) 1715, a system memory 1720, a network 1725, a read-only memory 1730, a permanent storage device 1735, input devices 1740, and output devices 1745.

The bus 1705 collectively represents all system, peripheral, and chipset buses that communicatively connect the numerous internal devices of the electronic system 1700. For instance, the bus 1705 communicatively connects the processing unit(s) 1710 with the read-only memory 1730, the GPU 1715, the system memory 1720, and the permanent storage device 1735.

From these various memory units, the processing unit(s) 1710 retrieves instructions to execute and data to process in order to execute the processes of the invention. The processing unit(s) may be a single processor or a multi-core processor in different embodiments. Some instructions are passed to and executed by the GPU 1715. The GPU 1715 can offload various computations or complement the image processing provided by the processing unit(s) 1710. In some embodiments, such functionality can be provided using CoreImage's® kernel shading language.

The read-only-memory (ROM) 1730 stores static data and instructions that are needed by the processing unit(s) 1710 and other modules of the electronic system. The permanent storage device 1735, on the other hand, is a read-and-write memory device. This device is a non-volatile memory unit that stores instructions and data even when the electronic system 1700 is off. Some embodiments of the invention use a mass-storage device (such as a magnetic or optical disk and its corresponding disk drive) as the permanent storage device 1735.

Other embodiments use a removable storage device (such as a floppy disk, flash memory device, etc., and its corresponding drive) as the permanent storage device. Like the permanent storage device 1735, the system memory 1720 is a read-and-write memory device. However, unlike storage device 1735, the system memory 1720 is a volatile read-and-write memory, such a random access memory. The system memory 1720 stores some of the instructions and data that the processor needs at runtime. In some embodiments, the invention's processes are stored in the system memory 1720, the permanent storage device 1735, and/or the read-only memory 1730. For example, the various memory units include instructions for processing multimedia clips in accordance with some embodiments. From these various memory units, the processing unit(s) 1710 retrieves instructions to execute and data to process in order to execute the processes of some embodiments.

The bus 1705 also connects to the input and output devices 1740 and 1745. The input devices 1740 enable the user to communicate information and select commands to the electronic system. The input devices 1740 include alphanumeric keyboards and pointing devices (also called “cursor control devices”), cameras (e.g., webcams), microphones or similar devices for receiving voice commands, etc. The output devices 1745 display images generated by the electronic system or otherwise output data. The output devices 1745 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 17, bus 1705 also couples electronic system 1700 to a network 1725 through a network adapter (not shown). In this manner, the computer can be a part of a network of computers (such as a local area network (“LAN”), a wide area network (“WAN”), or an Intranet, or a network of networks, such as the Internet. Any or all components of electronic system 1700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures (including FIGS. 2, 5, 10, and 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method of authoring a document, the method comprising:
identifying a mathematical object in the document;
constructing a search tree by parsing the mathematical object, wherein each leaf node of the search tree corresponds to a symbol in the mathematical object;
identifying an alignment relational operator from the search tree; and
aligning the mathematical object to a particular position in the document at the identified alignment relational operator.

2. The method of claim 1 further comprising traversing the search tree in a depth first manner.

3. The method of claim 2 further comprising recording an index when encountering a relational operator during the traversing of the search tree.

4. The method of claim 3, wherein identifying the alignment operator further comprises identifying a relational operator with an earliest index.

5. The method of claim 3, wherein identifying the alignment operator further comprises excluding relational operators that are visually nested.

6. The method of claim 3, wherein identifying the alignment operator further comprises identifying visually nested relational operators.

7. The method of claim 6, wherein a visually nested relational operator is associated with a node that is deeper than a particular level in the search tree.

8. The method of claim 3, wherein identifying the alignment operator further comprises excluding a relational operator that is within a radical.

9. The method of claim 3, wherein identifying the alignment operator further comprises excluding a relational operator that is within a fraction.

10. The method of claim 3, wherein identifying the alignment operator further comprises excluding a relational operator that is within a subscript or a superscript.

11. The method of claim 1, wherein the mathematical object is a first mathematical object, the method further comprising aligning a second mathematical object to the particular position by identifying an alignment relational operator in the second mathematical object.

12. The method of claim 11, wherein the first and second mathematical objects are selected for centering operations.

13. A computer readable medium storing a computer program for authoring a document comprising a plurality of mathematical objects, the computer program for execution by one or more processing units, the computer program comprising sets of instructions for:
traversing, for each mathematical object in the plurality of mathematical objects, a search tree associated with the mathematical object;
aligning each mathematical object in the plurality of mathematical object based on said traversing of the search tree.

14. The computer readable medium of claim 13, wherein the set of instructions for traversing the search tree of the mathematical object comprises identifying an alignment symbol in the mathematical object.

15. The computer readable medium of claim 14, wherein identifying the alignment symbol comprises identifying an earliest relational operator encountered during said traversing that is not visually nested.

16. The computer readable medium of claim 14, wherein the set of instructions for aligning each mathematical object comprises moving a mathematical object for which an alignment symbol is identified to a position such that the identified alignment symbol is aligned with a center position in the document.

17. The computer readable medium of claim 13, wherein the set of instructions for aligning comprises determining whether an alignment symbol can be identified from the search tree associated with the mathematical object.

18. The computer readable medium of claim 17, wherein the set of instructions for aligning each mathematical object comprises moving a mathematical object for which an alignment symbol cannot be identified during said traversing to a position such that two boundaries of the mathematical objects are equally spaced from two margins of the documents.

19. The computer readable medium of claim 13, wherein said aligning is part of a center-alignment operation.

20. A system for authoring an electronic document, the system comprising:
a user interface module that selects a portion of the document, wherein the portion of the document comprises at least one mathematical object; and
a format editing module that centers the selected portion of the document by identifying an alignment relational operator in the mathematical object and aligns the mathematical object to a particular position in the document at the identified alignment relational operator.

21. The system of claim 20 further comprising a module for constructing a search tree by parsing the mathematical object, wherein each leaf node of the search tree corresponds to a symbol in the mathematical object.

22. The system of claim 21, wherein the format editing module traverses the search tree in a depth first manner.

23. The system of claim 22, wherein the format editing module identifies a relational operator that is encountered before any other relational operator during the traversal of the search tree as the alignment relational operator.

24. The system of claim 20, wherein the format editing module excludes relational operators that are visually nested when identifying the alignment operator.

25. The system of claim 20, wherein the particular position is the center of a page of the electronic document.

26. The system of claim 20, wherein the particular position is the center of a cell of a table in the electronic document.
